(19) United States
(12) Patent Application Publication
(10) Pub. No.: US 2008/0010224 A1
(43) Pub. Date: Jan. 10, 2008

(54) Method of storing and distributing regulated goods

(76) Inventors: Todd D. Graham, Houston, TX (US); Michael J. Anders, Houston, TX (US)

Correspondence Address: Ted M. Anthony, Suite 1200, 600 Jefferson Street, Lafayette, LA, 70501, US

(21) Appl. No.: 11/166,295

(22) Filed: Jun. 24, 2005

(51) Int. Cl. G06F 17/00

(52) U.S. Cl. 705/500; 705/26

(57) ABSTRACT

A segregated area for the storage of regulated goods is subleased or otherwise acquired from the operator of a warehouse that is used to store unregulated goods. The segregated area can be manned with support personnel, and appropriately isolated or otherwise separated from the remainder of the host warehouse in accordance with applicable regulations. Upon receipt of a purchase order, regulated goods are transported, ideally along with unregulated goods, to a third party purchaser. Legal custody and control of such regulated goods is not transferred until such regulated goods are actually delivered to the ultimate purchaser.

### CROSS REFERENCES TO RELATED APPLICATIONS

NONE

### STATEMENTS AS TO RIGHTS TO INVENTIONS MADE UNDER FEDERALLY SPONSORED RESEARCH AND DEVELOPMENT

NONE

### BACKGROUND OF THE INVENTION

1. Field of the Invention

The present invention pertains to a method of storing and distributing goods that are subject to regulation by governmental and/or other regulatory authorities including, but not necessarily limited to, alcoholic beverages. More particularly, the present invention pertains to a method of improving efficiency and reducing redundancy in the storage and distribution of regulated goods.

2. Description of the Prior Art

In many jurisdictions, the storage, distribution and/or sale of certain goods are subject to significant regulation. By way of example, but not limitation, alcoholic beverages such as beer, wine, liquor and the like, are often heavily regulated by states and their political subdivisions. As a result, such regulated goods must be stored, distributed and sold in accordance with detailed regulations promulgated by legislative bodies and/or applicable regulatory agencies.

Frequently, such regulation imposes additional requirements that would not otherwise exist for unregulated goods. These additional requirements can often translate into increased costs. In some cases, such costs are not consequential. However, in many cases, such increased costs can be extremely significant.

In certain locations, alcoholic beverages are heavily regulated, and must be distributed in accordance with specific rules established by applicable regulatory agencies. Often, such regulations mandate that alcoholic beverages must be transported or stored by individuals or business entities having specific licenses. Moreover, such regulations often require such alcoholic beverages to be stored apart from other types of food and/or beverages. As such, distributors of alcoholic beverages have typically maintained their inventory of alcoholic beverages in separate facilities which are used exclusively to house such goods. When a purchase order for alcoholic beverages is received, such as from a grocery store or other retail outlet, alcoholic beverage distributors typically retrieve the ordered goods from a dedicated storage facility and arrange for transportation of such alcoholic beverage(s) from the storage facility to the store or other location on a vehicle carrying only such alcoholic beverages.

This common scenario is inefficient, and therefore wasteful. First, use of dedicated storage facilities can be extremely expensive. Such facilities must be relatively large, and must be constructed, leased or purchased at some cost. Further, such dedicated storage facilities often have significant energy consumption requirements. Second, the regulated goods must be transported, typically via dedicated carrier(s), from such storage facilities to their ultimate destinations (e.g., stores, retail outlets, etc.). At the heart of the inefficiency lies the singular use to which these operational assets are put.

Thus, it is an object of the present invention to provide a new and unique method of storing and distributing regulated goods which improves efficiency and reduces redundancy associated with current methods of handling regulated goods.

### SUMMARY OF THE INVENTION

The present invention comprises a method of storing and distributing regulated goods including, but not necessarily limited to, alcoholic beverages and the like. The method of the present invention improves the efficiency of current methods of storing and distributing such regulated goods.

The present invention comprises the establishment of at least one isolated area for the storage of regulated goods within, or at least in general proximity to, a warehouse or storage facility used for storing unregulated goods. For example, in the case of alcoholic beverages, certain governmental regulations require that alcoholic beverages be maintained separate and apart from other unregulated goods. Thus, pursuant to the method of the present invention, alcoholic beverages are stored within specified, segregated portions of warehouses and/or other facilities used to store groceries and/or other unregulated goods. In the preferred embodiment of the present invention, such alcoholic beverages are stored in segregated area(s) of larger general use warehouses, such as wholesale grocery warehouses.

In the preferred embodiment of the present invention, a segregated area is subleased or otherwise acquired from the operator of a warehouse that is used to store unregulated goods. If necessary, such area can be manned with a dedicated support staff, and appropriately separated from the rest of such main warehouse, so as to adequately segregate regulated goods from non-regulated goods in accordance with applicable regulations. Significantly, the regulated goods are not stored with, and do not come in direct contact with, unregulated goods.

Moreover, in the preferred embodiment, an automated system is provided for efficiently handling the ordering of regulated goods. When orders are received for the purchase of regulated goods, such regulated goods can be transported, ideally along with unregulated goods on the same transport being used to deliver such unregulated goods, directly to a third party purchaser. However, legal custody and control of the regulated goods is never transferred until such goods are actually delivered to said third party purchaser.

### BRIEF DESCRIPTION OF THE DRAWINGS

FIG. 1 is a flow chart illustrating a method for storing and distributing regulated goods according to the present invention.

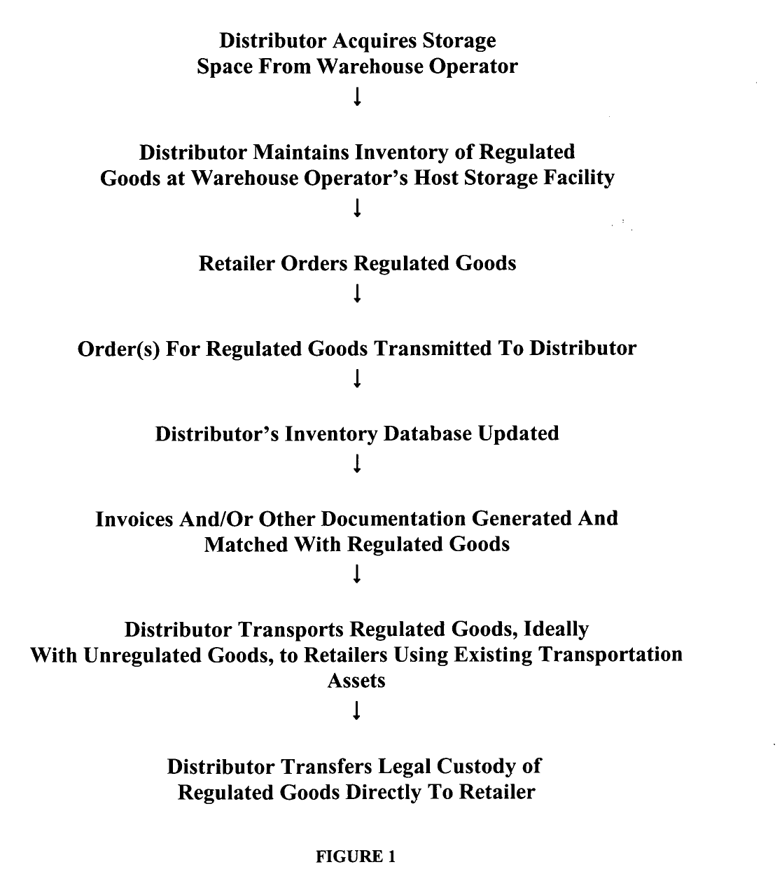

### DETAILED DESCRIPTION OF THE PRESENT INVENTION

The present invention comprises the establishment of at least one segregated area for the storage of regulated goods within, or at least in general proximity to, a warehouse or storage facility used for the storage of unregulated goods. For purposes of this disclosure, alcoholic beverages, which are heavily regulated by various governmental agencies, are used as an example to illustrate the method of the present invention. However, it is to be observed that the method of the present invention can also be utilized in connection with various other types of regulated goods. Accordingly, while alcoholic beverages are used herein as an example, the scope of the present invention is much broader and should not be construed as being limited only to alcoholic beverages.

In the case of alcoholic beverages, applicable governmental regulations require that such goods be stored separate and apart from other unregulated goods. As such, distributors of alcoholic beverages are generally required to maintain separate, dedicated warehouses for the storage of alcoholic beverages, as well as separate inventory control systems to track such alcoholic beverages. Likewise, alcoholic beverage distributors are generally required to provide dedicated transportation for delivery of such alcoholic beverages to retail outlets or other purchasers.

In the preferred embodiment of the present invention, a licensed or authorized distributor (“Distributor”) of regulated goods, such as alcoholic beverages, will sublease or otherwise acquire space from the operator (“Warehouse Operator”) of a warehouse that is used to store unregulated goods. Such unregulated goods may include, for example, groceries or other foodstuffs; however, it is to be observed that the unregulated goods stored in the host warehouse may or may not bear some similarity or relationship to the regulated goods.

If necessary, the subleased area can be staffed with dedicated support personnel, and appropriately isolated or otherwise separated from the rest of such main warehouse so as to adequately segregate regulated goods from non-regulated goods in accordance with applicable regulations. For example, in the case of alcoholic beverages, the regulated goods are physically separated from unregulated goods, such as groceries and/or other basic foodstuffs.

When a third party, such as the owner/operator of a retail outlet (“Retailer”), contracts with the Distributor for the purchase of regulated goods, an order for such regulated goods is transmitted to the Distributor. In the preferred embodiment, an order for regulated goods is transmitted by or on behalf of the Retailer utilizing an electronic ordering system. The order can be placed directly by the Retailer or, if desired by an agent acting on behalf of the Retailer.

The Retailer's order for regulated goods can be conveyed directly to the Distributor. Alternatively, such order may be transmitted to the Warehouse Operator first and, thereafter, conveyed to the Distributor. In certain circumstances, such as when an order is being placed for both regulated goods stocked by the Distributor, as well as unregulated goods stocked by the Warehouse Operator, it may be preferable to transmit such a combined order to the Warehouse Operator at one time. Under such a scenario, upon receipt of the combined order the Warehouse Operator will communicate the order for regulated goods to the Distributor.

Upon receipt of an order for regulated goods, the Distributor will prepare the order for shipping. In most cases, the Distributor will be required to maintain separate inventory control records in order to comply with applicable regulations. In such cases, the Distributor will be required to account for all orders of regulated goods using a separate and fully independent inventory database.

In the preferred embodiment, appropriate invoices are generated for the regulated goods based on the order(s) received by the Distributor, and the regulated goods are prepared for shipping by the Distributor. Where required by applicable regulation, such invoice(s) are affixed to or otherwise shipped with the regulated goods to the Retailer.

It is to be observed that the aforementioned ordering process can be accomplished in any number of different ways. For example, regulated goods can be ordered in this manner over the telephone or via facsimile transmission. If time is not critical, such ordering can even be accomplished using regular mail or commercial courier service. However, in the preferred embodiment, order(s) are first entered on a computer by or on behalf of Retailer. Such orders are thereafter transmitted to the Warehouse Operator and, ultimately, to the Distributor over the Internet.

In the preferred embodiment, the Distributor maintains a computerized inventory system. Upon receipt of order(s) for the purchase of regulated goods by or on behalf of the Retailer, the Distributor's inventory system is automatically updated to reflect such purchase(s). Further, such information is also used to generate appropriate invoices and/or other documentation at the Distributor's storage facility where the regulated goods are stored. Payment can be made at the time of purchase or, alternatively, in response to such invoices.

The regulated goods identified in the purchase order(s) are selected from the Distributor's segregated warehouse space. Such regulated goods are packaged and, if required by applicable regulation, matched with the appropriate invoices or documentation. The regulated goods are thereafter transported, ideally along with unregulated goods, on the same transport used to deliver unregulated goods to the Retailer. In the preferred embodiment, existing transportation assets of the Warehouse Operator are used to transport such regulated goods also in a segregated manner where applicable regulations require. At no time do such regulated goods leave the legal custody or control of the Distributor until the regulated goods are actually delivered to the Retailer.

Although not absolutely required, it is often beneficial for the Distributor and Warehouse Operator to have some form of common relationship with the Retailer. For instance, using alcoholic beverages as an example for illustration purposes, an alcoholic beverage distributor can sublease warehouse space from a grocery wholesaler having an existing warehouse and, where required by regulation, physically separate the regulated goods from the unregulated goods within that warehouse. An order can be transmitted from a grocery store or other retail outlet to the alcoholic beverage distributor using electronic mail or some other form of electronic communication. The alcoholic beverage distributor's computerized inventory database is automatically updated, and appropriate invoices or other documentation are generated. The purchased alcoholic beverages can be transported from the subleased warehouse location directly to such grocery store using existing transportation assets of the grocery wholesaler.

Thus, such alcoholic beverages can be transported along with other groceries from the alcoholic beverage distributor's warehouse to the third party purchaser's grocery store or retail outlet. Under this scenario, both regulated and unregulated goods are transported in a single shipment (regulated where necessary), thereby reducing the number of required delivery runs, increasing asset utilization for both businesses and greatly reducing overall costs.

The above-described invention has a number of particular features which should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A method of distributing regulated goods comprising the steps of:
a. Establishing a segregated area within a storage facility containing unregulated goods;
b. Storing regulated goods within said segregated area;
c. Selecting certain regulated goods from said segregated area; and
d. Delivering said selected regulated goods to a purchaser.

2. The method of claim 1, wherein said selected regulated goods are delivered with unregulated goods using a common means of transportation.

3. The method of claim 2, wherein said common means of transportation is a truck.

4. A method of distributing regulated goods comprising the steps of:
a. Establishing a storage area within a storage facility containing unregulated goods, wherein said storage area is segregated from said unregulated goods;
b. Storing regulated goods within said segregated storage area;
c. Receiving a purchase order for regulated goods;
d. Selecting regulated goods described in said purchase order from said segregated storage area; and
e. Delivering said selected regulated goods to a purchaser.

5. The method of claim 4, wherein said purchase order is transmitted over the Internet.

6. The method of claim 4, wherein said regulated goods are delivered with unregulated goods using a common means of transportation.

7. The method of claim 6, wherein said common means of transportation is a truck.

8. The method of claim 4, comprising the further step of receiving payment for such regulated goods from said purchaser.

9. A method of distributing regulated goods comprising the steps of:
a. Establishing a storage area within a storage facility containing unregulated goods, wherein said storage area is segregated from said unregulated goods;
b. Storing regulated goods within said segregated storage area;
c. Receiving a purchase order for regulated goods;
d. Selecting regulated goods described in said purchase order from said segregated storage area;
e. Generating at least one invoice for such selected regulated goods; and
f. Delivering said selected regulated goods and said at least one invoice to a purchaser.

10. The method of distributing regulated goods of claim 9, wherein said purchase order is transmitted over the Internet

11. The method of distributing regulated goods of claim 9, wherein said regulated goods are delivered with unregulated goods using a common means of transportation.

12. The method of distributing regulated goods of claim 11, wherein said common means of transportation is a truck.

13. The method of distributing regulated goods of claim 9, comprising the further step of receiving payment for such regulated goods from said purchaser.

14. A method of distributing regulated goods comprising the steps of:
a. Establishing a storage area within a storage facility containing unregulated goods, wherein said storage area is segregated from said unregulated goods;
b. Storing regulated goods within said segregated storage area;
c. Maintaining an inventory database for said regulated goods;
d. Providing personnel to staff said segregated storage area;
e. Receiving a purchase order for regulated goods;
f. Updating said inventory database to reflect said purchase order;
g. Selecting regulated goods described in said purchase order from said segregated storage area;
h. Generating at least one invoice for such selected regulated goods; and
i. Delivering said selected regulated goods and said at least one invoice to a purchaser.

15. The method of distributing regulated goods of claim 14, wherein said purchase order is transmitted over the Internet.

16. The method of distributing regulated goods of claim 14, wherein said regulated goods are delivered with unregulated goods using a common means of transportation.

17. The method of distributing regulated goods of claim 16, wherein said common means of transportation is a truck.

18. The method of distributing regulated goods of claim 14, comprising the further step of receiving payment for such regulated goods from said purchaser.

19. The method of distributing regulated goods of claim 14, wherein the steps of maintaining an inventory database for said regulated goods, receiving a purchase order for regulated goods, updating said inventory database to reflect said purchase order and generating at least one invoice for such selected regulated goods are performed using at least one computer.
